(19) United States
(12) Patent Application Publication
(10) Pub. No.: US 2007/0137689 A1
(43) Pub. Date: Jun. 21, 2007

(54) CONNECTION DEVICE HAVING A DIODE FOR CONNECTING AN ELECTRICAL CONDUCTOR TO A CONNECTING LEAD

(76) Inventors: Gunter Feldmeier, Lorsch (DE); Andreas Woeber, Kronau (DE); Heinz Scherer, Bensheim (DE)

Correspondence Address: BARLEY SNYDER, LLC, 1000 WESTLAKES DRIVE, SUITE 275, BERWYN, PA, 19312, US

(21) Appl. No.: 11/548,770

(22) Filed: Oct. 12, 2006

(30) Foreign Application Priority Data
Oct. 20, 2005 (DE) 102005050314.4

(51) Int. Cl. H02N 6/00

(52) U.S. Cl. 136/244

(57) ABSTRACT

A connection device for connecting at least one electrical conductor to at least one connecting lead includes a connector housing having at least one connecting lead receiving through-hole and at least one electrical conductor receiving through-hole. An intermediate connection arrangement is arranged in the connector housing and has a first connection area configured for connecting the connecting lead and a second connection area configured for connecting the electrical conductor. The intermediate connection arrangement includes a substrate arrangement having an electrical conductor structure and a thermal conduction structure. The electrical conductor structure is configured for electrically connecting the first and second connection areas, and the thermal conduction structure is configured to dissipate thermal energy from at least one diode. The diode has substantially flat opposing main faces and is electrically connected to the electrical conductor structure. At least one of the main faces is connected to the thermal conduction structure.

### FIELD OF THE INVENTION

The invention relates to a connection device for connecting at least one electrical conductor to at least one connecting lead, the connection device having an intermediate connection arrangement having at least one diode. A connection device of this type is configured in particular for the electrical connection of solar cells of a solar module.

### BACKGROUND OF THE INVENTION

A solar module for generating electrical energy typically comprises a layered arrangement having a planar first layer on an exposed side, for example, a glass cover having a low level of absorption, and a planar second layer on a rear side, for example, a glass cover. Individual solar cells, which contribute to generating electrical energy by a photovoltaic effect, are arranged between the first layer and the second layer and are interconnected inside the layered arrangement. The solar panel formed in this way is normally provided with a surrounding connector housing. In order to obtain higher voltages and currents, a plurality of the solar cells is combined into a solar module and is connected in series or parallel to each other.

In traditional solar modules, connecting foils are normally used to make contact with the rear sides of the solar cells, which are separate from the exposed side. The connecting foils are connected to connecting leads, also known as solar leads, by a connection device in the form of a connection box. This connection is made, for example, by soldering, screwing, or using clips that clamp the connecting foil onto a conductor rail.

Normally the connection device for the electrical connection of the solar cells of the solar module contains one or more diodes, which are provided to prevent equalization currents between the solar cells lying in sunlight and the solar cells lying in shadow, which supply different solar currents and solar voltages. The solar module can thereby continue to work even under partial shadowing and correspondingly reduced power. Such bypass diodes, as they are known, traditionally have a rounded configuration, which means that they can only have limited use, in particular for high powers. Comparatively high losses occur in the diode, in particular in the case of high powers, which have to be dissipated in the form of heat or thermal energy to the outside of the connection device. In the connection device previously discussed, however, there is relatively poor dissipation of the thermal energy when a diode having a rounded configuration is used.

### BRIEF SUMMARY OF THE INVENTION

An object of the present invention is therefore to provide a connection device, which is suitable for connecting an electrical conductor, in particular of a solar module, to a connecting lead, even in the cases where high powers are to be carried.

This and other objects are achieved by a connection device for connecting at least one electrical conductor to at least one connecting lead. The connection device includes a connector housing having at least one connecting lead receiving through-hole and at least one electrical conductor receiving through-hole. An intermediate connection arrangement is arranged in the connector housing and has a first connection area configured for connecting the connecting lead and a second connection area configured for connecting the electrical conductor. The intermediate connection arrangement includes a substrate arrangement having an electrical conductor structure and a thermal conduction structure. The electrical conductor structure is configured for electrically connecting the first and second connection areas, and the thermal conduction structure is configured to dissipate thermal energy from at least one diode. The diode has substantially flat opposing main faces. The diode is electrically connected to the electrical conductor structure and at least one of the main faces of the diode is connected to the thermal conduction structure.

### BRIEF DESCRIPTION OF THE DRAWINGS

FIG. 1 is a schematic side view of a solar module provided with a connection device according to the invention;

FIG. 2 is a perspective view of a first embodiment of the connection device according to the invention;

FIG. 3 is a perspective view of an intermediate connection arrangement of the connection device shown in FIG. 2;

FIG. 4 is a perspective view of a rear side of the intermediate connection arrangement of the connection device shown in FIG. 2;

FIG. 5 is a plan view of an alternate embodiment of the intermediate connection arrangement according to the invention;

FIG. 6 is a perspective view of the intermediate connection arrangement shown in FIG. 5 having an encapsulation material applied thereto and connecting webs removed;

FIG. 7A is a side view of the intermediate connection arrangement shown in FIG. 6 before the connecting webs are removed;

FIG. 7B is another side view of the intermediate connection arrangement shown in FIG. 6 before the connecting webs are removed;

FIG. 7C is plan view of the intermediate connection arrangement shown in FIG. 6 before the connecting webs are removed;

FIG. 7D is a plan view of the intermediate connection arrangement shown in FIG. 6;

FIG. 8 is a perspective view of a further embodiment of the intermediate connection arrangement according to the invention;

FIG. 9 is a perspective view of a further embodiment of the intermediate connection arrangement according to the invention having an encapsulation material applied thereto;

FIG. 10 is a partial cross-sectional perspective view of a second embodiment of the connection device according to the invention;

FIG. 11 is a perspective view of a third embodiment of the connection device according to the invention; and

FIG. 12 is a perspective view of the connection device shown in FIG. 11 with a housing cover.

### DETAILED DESCRIPTION OF THE INVENTION

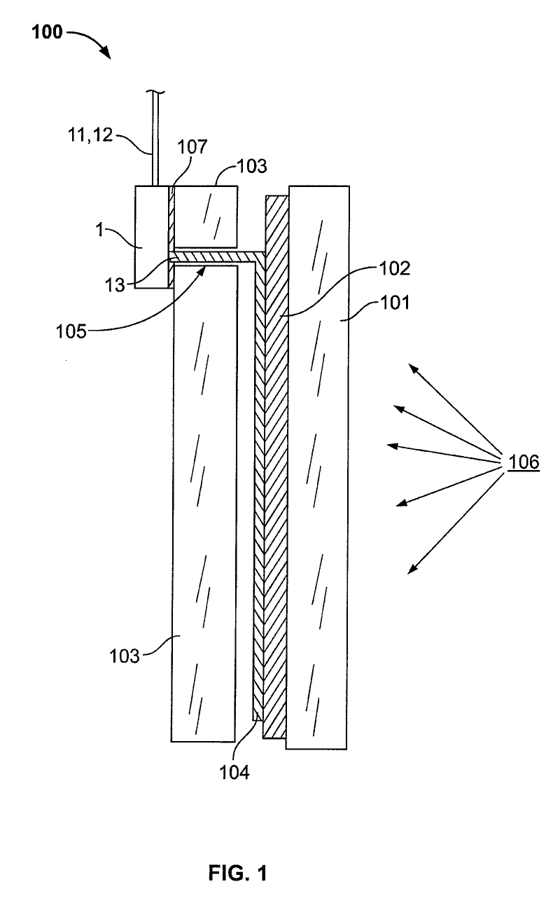

FIG. 1 shows a solar module 100 provided with a connection device 1 according to the invention. As shown in FIG. 1, the solar module 100 comprises a layered arrangement having a substantially planar first layer 101 and a substantially planar second layer 103. The first layer 101 is on an exposed side of the solar module 100 and may be formed, for example, from a glass plate. The second layer 103 may be formed, for example, from a glass plate or a protective film and is provided with one or more through-holes 105. The connection device 1 may be attached to a rear side of the second layer 103, for example, by an adhesive 107, such as glue.

At least one solar cell 102 is arranged between the first layer 101 and the second layer 103. The solar cell 102 supplies electrical energy when the solar cell 102 is exposed to light rays 106 from, for example, sunlight. A conductor foil 104 carries the energy away from the solar cell 102. The conductor foil 104 may be, for example, in the form of a copper foil that forms a conductor pattern. For this purpose, the conductor foil 104 is electrically connected on one side to an unexposed rear side of the solar cell 102 and on the other side via an electrical conductor 13 fed through the through-hole 105 to the connection device 1. The electrical conductor 13 may be, for example, a foil conductor. The energy is then taken from the connection device 1 out to a load (not shown) through connecting leads 11, 12.

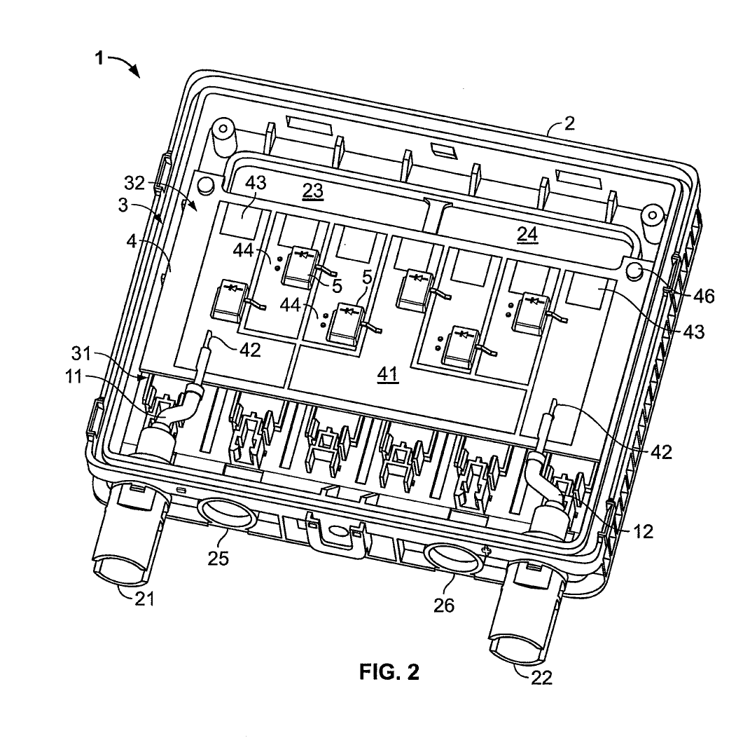

FIGS. 2-9 show a first embodiment of the connection device 1 according to the invention. As shown in FIG. 2, the connection device 1 comprises a connector housing 2 having connecting lead receiving through-holes 21, 22 configured for feeding out the connecting leads 11, 12 and electrical conductor receiving through-holes 23, 24 configured to receive the electrical conductor 13. In the illustrated embodiment, the electrical conductor receiving through-holes 23, 24 are provided in the form of slots, such that a plurality of the electrical conductors 13 may be introduced into an interior of the connector housing 2.

As shown in FIG. 2, an intermediate connection arrangement 3 is formed in the interior of the connector housing 2. The intermediate connection arrangement 3 consists of a substrate arrangement in the form of a printed circuit board 4, which comprises tracks 41 applied to the printed circuit board 4 to create an electrical conductor structure. The intermediate connection arrangement 3 has a first connection area 31 for connecting the connecting leads 11, 12, and a second connection area 32 for connecting the electrical conductors 13. In the first connection area 31, electrical terminals 42 are provided on the printed circuit board 4, which are configured, for example, as plug-in tongues, which may be plugged-into cable lugs of the connecting leads 11, 12. In the second connection area 32, dimensionally stable planar conductors 43 are provided on the printed circuit board 4, which are configured to provide a flat contact surface for foil-type connection areas (not shown) of the electrical conductors 13. The foil-type connection areas (not shown) may, for example, be soldered on the planar conductors 43.

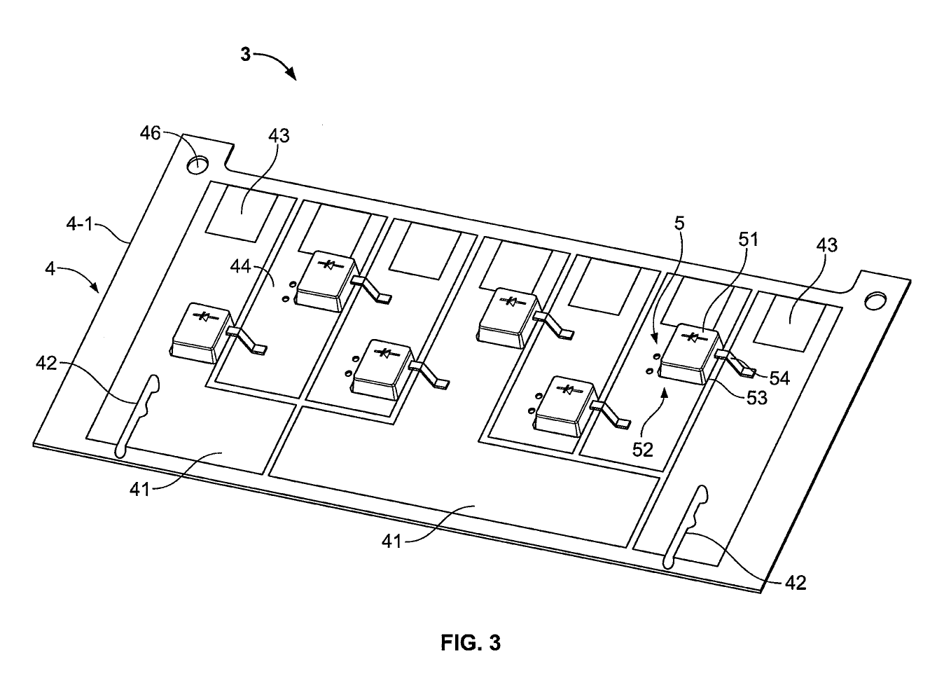

The printed circuit board 4 is fixed to the connector housing 2 by inserting an attachment member (not shown), such as a screw, through an opening 46 in the printed circuit board 4, as shown in FIG. 3. As shown in FIG. 2, the connector housing 2 is illustrated as having further housing structures below the printed circuit board 4. Because these further housing structures perform no essential function with regard to the present invention, but are provided in the connector housing 2 so that the connector housing 2 can be used for other applications, further description thereof will be omitted.

As shown in FIG. 3, a plurality of diodes 5 configured as flat diodes are mounted on the tracks 41 of the printed circuit board 4. The diodes 5 have two substantially flat opposing main faces 51, 52. One of the main faces 51 forms a visible top side of the diode 5, and the other of the main faces 52 forms a non-visible underside of the diode 5. The main faces 51, 52 are joined by respective side faces 53, so that the main faces 51, 52 and the side faces 53 form a diode 5 that is substantially cuboid in shape. The main faces 51, 52 are significantly larger than the side faces 53.

As shown in FIG. 3, each of the diodes 5 is connected via a lead 54 to the tracks 41 of the printed circuit board 4. In the illustrated embodiment, each of the diodes 5 is connected via a lead 54 to the track 41 adjacent to the respective diode 5. A second electrical connection to the track 41 is made via a second lead (not shown) connected to the underside of the diode 5. The track 41 on which one of the diodes 5 is mounted is connected in this way to an adjacent track 41 via the corresponding diode 5.

In the illustrated embodiment, the diodes 5 provided on the front side of the printed circuit board 4 are of a similar type and are arranged mutually offset in a plane of the printed circuit board 4 (for example, diagonally offset from transverse and longitudinal axes of the printed circuit board 4). This type of arrangement increases the distance between the diodes 5 in order to reduce the thermal effect of the diodes 5. In an alternate embodiment, however, it would also be possible to arrange the diodes 5 side-by-side in a row (for example, along the longitudinal axis of the printed circuit board 4).

In the connection arrangement shown in FIG. 3, the tracks 41 are interconnected in series via the diodes 5. Such a circuit is used in particular in the case where the individual solar cells 102 of the solar module 100 are interconnected into a solar-cell circuit, for example, into a serial connection of the individual solar cells 102. In this case, the solar-cell circuit is connected at individual, different circuit nodes to the respective planar conductors 43 of the second connection area 32 of the intermediate connection arrangement 3. Pairs of the circuit nodes of the solar-cell circuit are thereby interconnected via the diode 5. The diodes 5 hence act as respective bypass diodes, which divert a current past an assigned group of the solar cells 102 of the solar module 100 when one or more of the solar cells 102 of a corresponding group are not contributing, or only to a limited extent, to generating electrical energy, for example when there is partial shadowing.

The tracks 41 are therefore used for the electrical connection of the first connection area 31 and the second connection area 32 of the intermediate connection arrangement 3 via the respective diodes 5. Additionally, the tracks 41 are used as a thermal conduction structure for dissipating thermal energy from the diode 5, which is produced as waste heat in the respective diodes 5. Good heat transfer to the track 41 exists via the comparatively large area of the main face 52 of the diode 5, because the track 41 has a comparatively large surface area for emitting to the surroundings the heat absorbed from the respective diodes 5. The large area of the tracks 41 therefore acts as a thermal conductor, which in turn can dissipate the absorbed heat via, for example, an encapsulation material.

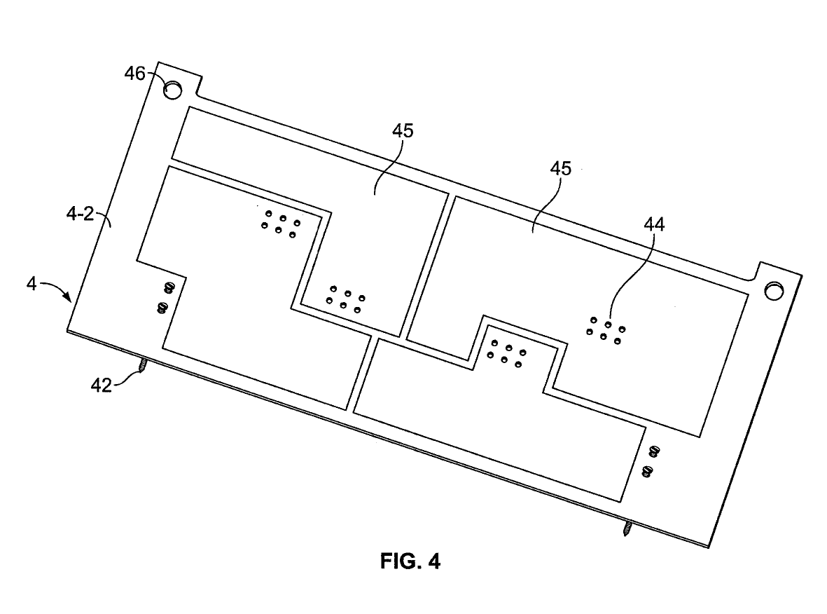

As shown in FIG. 4, the rear side 4-2 of the printed circuit board 4 has tracks 45. Unlike the tracks 41, the tracks 45 of the rear side 4-2 of the printed circuit board 4 are not interconnected but perform the function of a thermal conduction structure. The tracks 45 are connected to the tracks 41 on the front side 4-1 of the printed circuit board 4 via plated-through holes 44. Hence two partial thermal conduction structures are formed on the front and rear sides 4-1 and 4-2 of the printed circuit board 4 in the form of the tracks 41, 45, which are interconnected through the printed circuit board 4 by the plated-through holes 44. Thus, the surface area of the tracks 41 can be extended onto the rear side 4-2 of the printed circuit board 4, so that the surface area is increased for improved dissipation of thermal energy from the diodes 5.

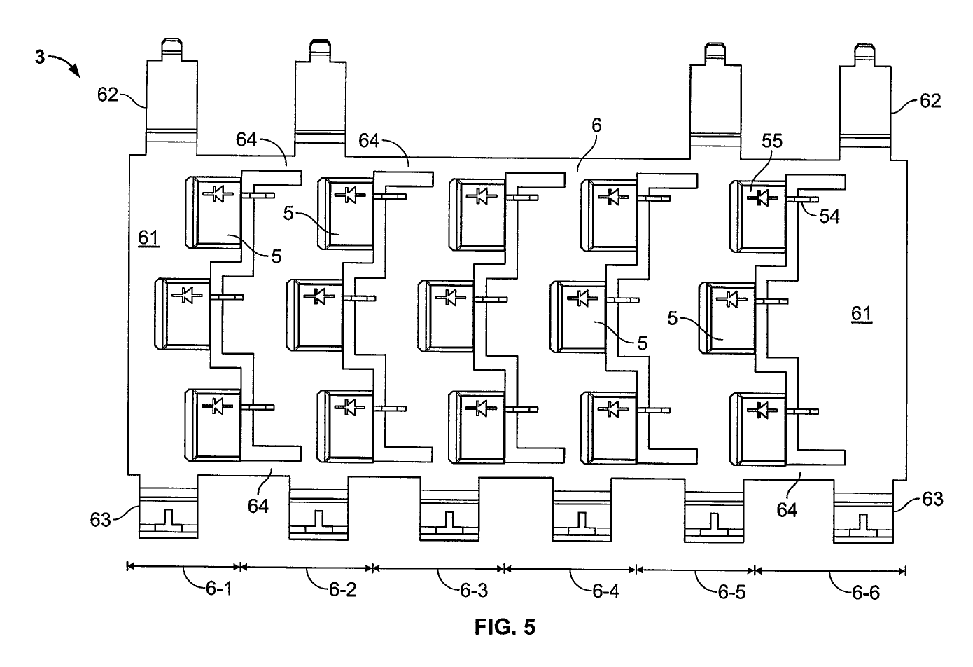

FIGS. 5-7D show an alternate embodiment of the intermediate connection arrangement 3, wherein the intermediate connection arrangement 3 has a punched grid 6 as the substrate arrangement instead of the printed circuit board 4. FIG. 5 shows a manufacturing stage of individual punched-grid members 6-1 to 6-6 of the punched grid 6 where the individual punched-grid members 6-1 to 6-6 are still interconnected via connecting webs 64. The individual punched-grid members 6-1 to 6-6 each have tracks 61 that act as an electrical conductor structure.

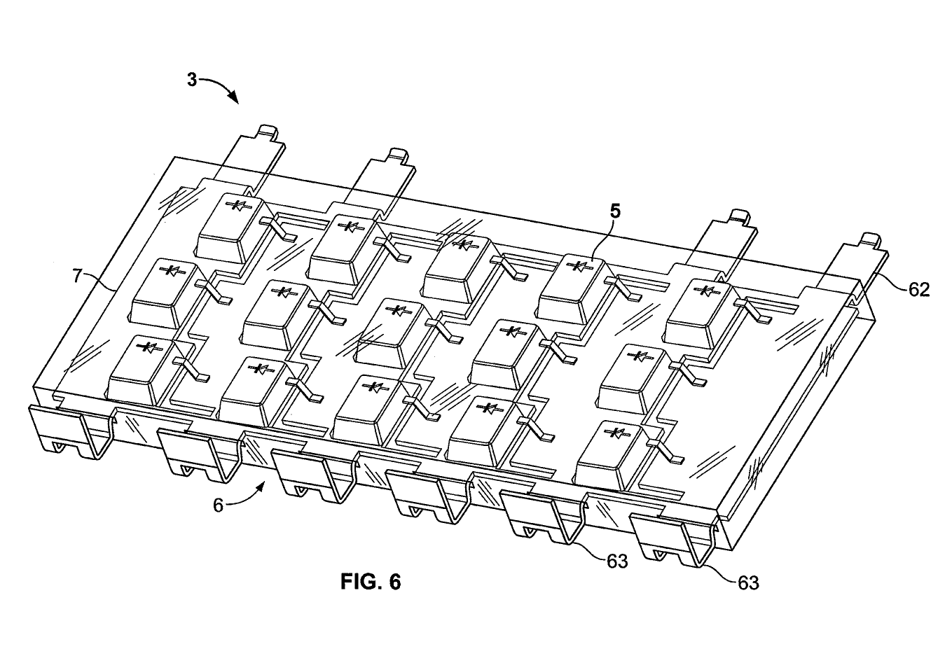

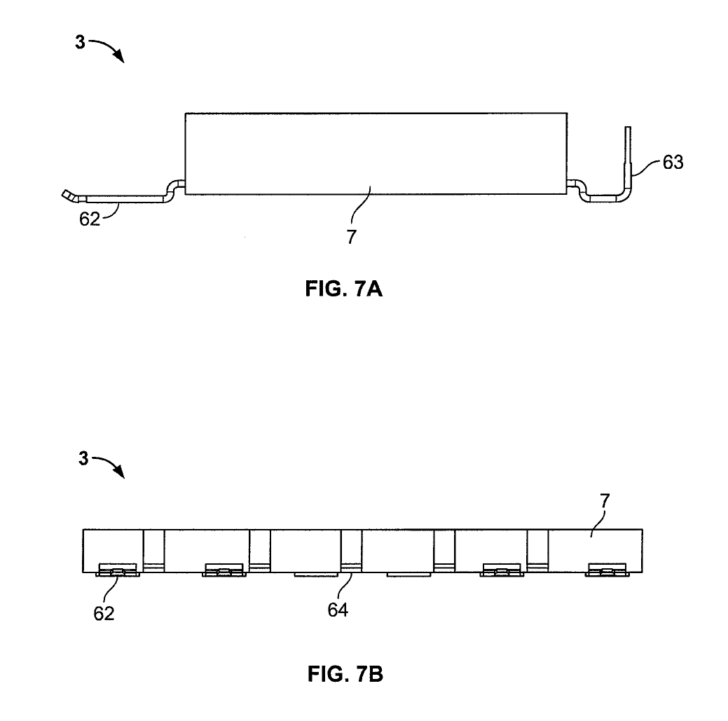

Each of the individual punched-grid members 6-1 to 6-6 has a dimensionally stable flat conductor 63 that acts as a substantially flat contact surfaces for the foil-type connection areas of the electrical conductors 13. As shown in FIG. 6, the flat conductors 63 are bent upwards so that the foil-type connection areas of the electrical conductors 13 may be connected, for example, via a spring clip to the flat conductors 63. As shown in FIG. 5, electrical terminals 62 are provided on an opposite side of the punched grid 6 to connect the intermediate connection arrangement 3 to the connecting leads 11, 12. As shown in FIG. 7D, the terminals 62 are provided, for example, with spring cage clamps 65 for clamping a wire of the respective connecting leads 11, 12.

As shown in FIG. 6, a plurality of diodes 5 are mounted on the punched grid 6 in substantially the same manner as the diodes 5 of the embodiment of the intermediate connection arrangement 3 described with reference to FIGS. 2-3. Each of the diodes 5 is connected to the adjacent individual punched-grid members 6-1 to 6-6 via leads 54, 55, as shown in FIG. 5. The interconnection of the individual punched-grid members 6-1 to 6-6 of the punched grid 6 is hence similar to the interconnection of the tracks 41 of the printed circuit board 4 described with reference to FIGS. 2-3. In the embodiment shown in FIGS. 5-6, however, three of the diodes 5 are connected in parallel with each other. It will be appreciated by those skilled in the art, however, that it would also be possible to connect more than or fewer than three of the diodes 5 in parallel with each other.

As shown in FIG. 6, after mounting the diodes 5 on the punched grid 6, an encapsulation material 7 is applied to the punched grid 6 to form a thermal conduction structure. The encapsulation material 7 encloses the diodes 5 such that the encapsulation material 7 makes contact with the diodes 5 and absorbs thermal energy there from. For example, the punched grid 6 is encapsulated or injection molded with the encapsulation material 7, which may be in the form of, for example, a thermoplastic polymer, to form what is known as a thermal overmolding. In one example, the product THERMELT from the company Werner Wirth GmbH, Germany may be used as the encapsulation material 7.

Improved dissipation of thermal energy from the diodes 5 to the surroundings can be achieved by using such a thermal overmolding. The large area of the individual punched-grid members 6-1 to 6-6 also act as a thermal conduction structure, which emit the generated heat to the encapsulation material 7 via the respective tracks 61. In addition, the heat capacity is increased, so that the dynamic performance is improved, because momentarily high levels of emitted heat can be absorbed. A further advantage is that by using the encapsulation material 7, an optional transition to a metal thermal conduction structure, for example, can be created, so that the overall thermal conductivity is increased. In addition, contact to the diode 5 is made over a larger surface area, which also increases the dissipated thermal energy.

In order to manufacture the punched grid 6, the punched grid 6 having the individual punched-grid members 6-1 to 6-6 is formed from a metal strip such that the individual punched-grid members 6-1 to 6-6 of the punched grid 6 are initially interconnected by the connecting webs 64, as shown in FIG. 5. For example, the metal strip may pass through a punching machine, which forms the individual punched-grid members 6-1 to 6-6. While leaving the connecting webs 64 intact, the diodes 5 are mounted on the punched grid 6, for example, by soldering.

The punched grid 6 is then inserted in a molding tool, for example, in a casting mold or injection-molding mold, in order to apply the encapsulation material 7, as shown in FIGS. 7A-7B. Here, openings 66 are formed so that the connecting webs 64 are externally accessible after creating the final cast shaped body, as shown in FIG. 7C. The connecting webs 64 are then severed by a suitable tool (not shown) by, for example, punching the connecting webs 64 through the openings 66, as shown in FIG. 7D. The intermediate connection arrangement 3 is then inserted in the connector housing 2 and the connecting leads 11, 12 and/or the electrical conductors 13 of the solar module 100 are connected thereto. The intermediate connection arrangement 3 is then fixed to the connector housing 2.

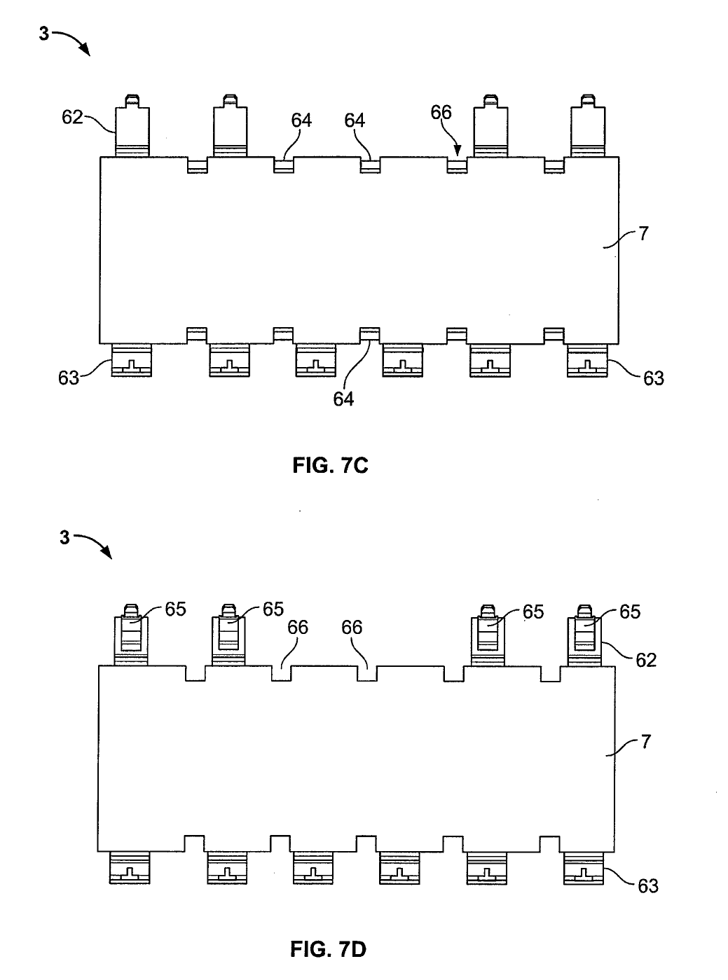

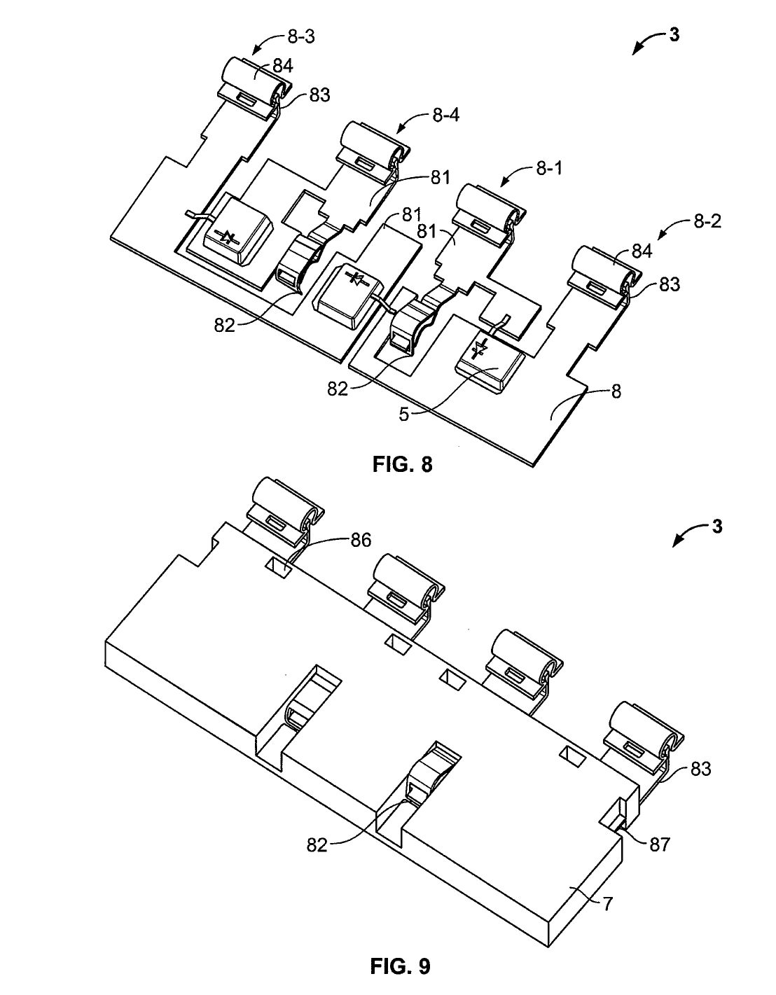

FIGS. 8-9 show a further alternate embodiment of the intermediate connection arrangement 3, wherein the intermediate connection arrangement 3 has a punched grid 8 as the substrate arrangement instead of the printed circuit board 4. As shown in FIG. 8, the punched grid 8 has a plurality of individual punched-grid members 8-1 to 8-4 connected by connecting webs that form a conductor structure having separate tracks 81. Main faces of diodes 5 are mounted on a plurality of the individual punched-grid members 8-1, 8-2, 8-4. Dimensionally stable flat conductors 83 that act as a flat contact surface for the foil-type connection areas of the electrical conductors 13 are formed on the individual punched-grid members 8-1 to 8-4 and are provided with spring clips 84 for clamping the foil-type connection areas of the electrical conductors 13 thereto. The spring clips 84 may be, for example, permanently elastic stainless steel springs or the spring cage clamps 65 described with reference to FIG. 7D. Terminals 82 extend from the individual punched-grid members 8-1, 8-4 and are configured for connection to the connecting leads 11, 12.

As shown in FIG. 9, after mounting the diodes 5 onto the punched grid 8, the punched grid 8 is encapsulated by an encapsulation material 7 such that openings 86 and cut-outs 87 are formed therein. The connecting webs of the punched grid 8 may be punched out though the openings 86. The intermediate connection arrangement 3 can be fixed in the connector housing 2 at the cut-outs 87. Unlike the previous embodiments, a systematic, series-type interconnection is not implemented by the punched grid 8, for example to allow the connecting foils to be interconnected in different ways on the solar module side. Hence the diode wiring can vary in form (variable track pattern), to allow different requirements on the solar module side to be taken into account.

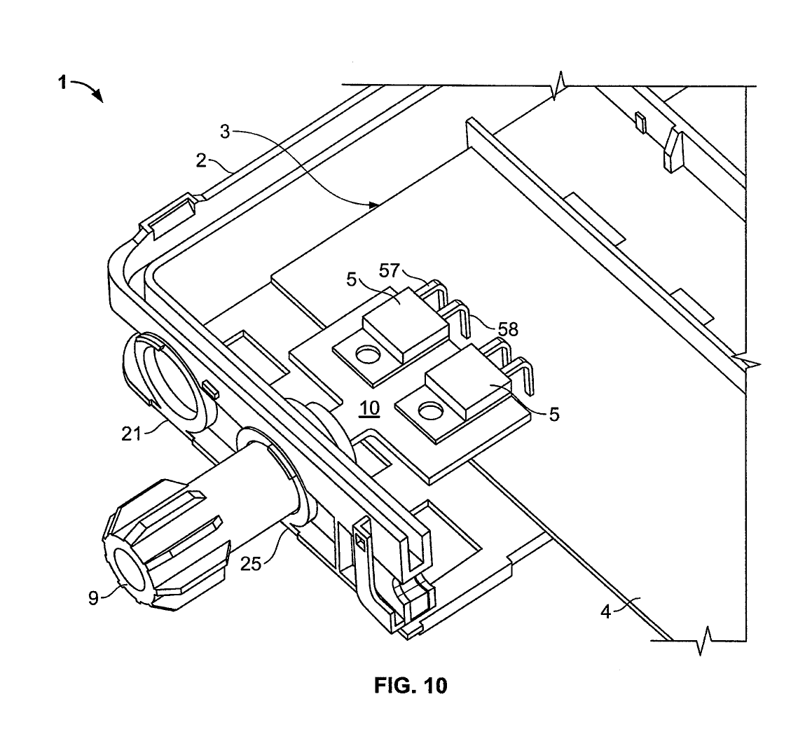

FIG. 10 shows a third embodiment of the connection device 1 according to the invention, wherein unlike the connection device 1 according to the first embodiment, the thermal conduction structure and the substrate arrangement in the form of a printed circuit board 4 having the electrical conductor structure are arranged separately from each other. As shown in FIG. 10, the thermal conduction structure is configured as a thermally conducting, substantially planar, metal plate 10. Main faces of diodes 5 are mounted on the metal plate 10 to provide optimal heat transfer. The diodes 5 are connected to the electrical conductor structure on the substrate arrangement by leads 57, 58. Where the electrical conductor structure is not shown in detail in FIG. 10, it is to be assumed that the electrical conductor structure has a similar configuration, for example, to the printed circuit board 4 described with reference to FIGS. 2-3. The arrangement of the metal plate 10, the diodes 5 and substrate arrangement shown in FIG. 10 can be embedded in the encapsulating material 7, as previously described with reference to FIGS. 6-7D.

The metal plate 10 having the diodes 5 mounted thereon and arranged in the connector housing 2 is connected to a thermal conductor 9. A thermal-conduction through-hole 25 is provided for this purpose in the connector housing 2 for the passage of the thermal conductor 9, which is connected to the metal plate 10. The thermal conductor 9 doubles as an external heat sink having attached ribs to increase the surface area, in order to improve dissipation of the thermal energy of the diodes 5 to an area outside the connector housing 2. The thermal conductor 9, which is not an electrical conductor, may be, for example, made from a plastic material to achieve optimal thermal conductivity to the outside of the connector housing 2. Additionally, no electrically conducting members of the second connection arrangement 3 are accessible outside of the connector housing 2.

As shown in FIG. 2, a further thermal-conduction through-hole 26 is provided on the right-hand side of the connector housing 2 for an additional metal plate. The diodes 5 can also be arranged on the additional metal plate, so that a multiplicity of the diodes 5 can be arranged in the connector housing 2. The thermal-conduction through-holes 25, 26 may alternatively be used in another application as extra connecting lead receiving through-holes.

In an alternative embodiment, it is also possible to mount the diodes 5 on the printed circuit board 4 as described with reference to FIGS. 2-3 and to provide the metal plate 10 as an additional part of the thermal conduction structure. In this embodiment, the diodes 5 on the printed circuit board 4 are enclosed by the encapsulation material 7, as described with reference to FIGS. 6-7D, and the metal plate 10 is also embedded in the encapsulation material 7. Heat is thereby transferred from the diodes 5 or the printed circuit board 4 via the encapsulation material 7 to the metal plate 10, which in turn is connected to a thermal conductor, similar to the thermal conductor 9 described with reference to FIG. 10. Hence, heat from the diodes 5 is dissipated to the outside of the connector housing 2 via the encapsulation material 7 and the metal plate 10.

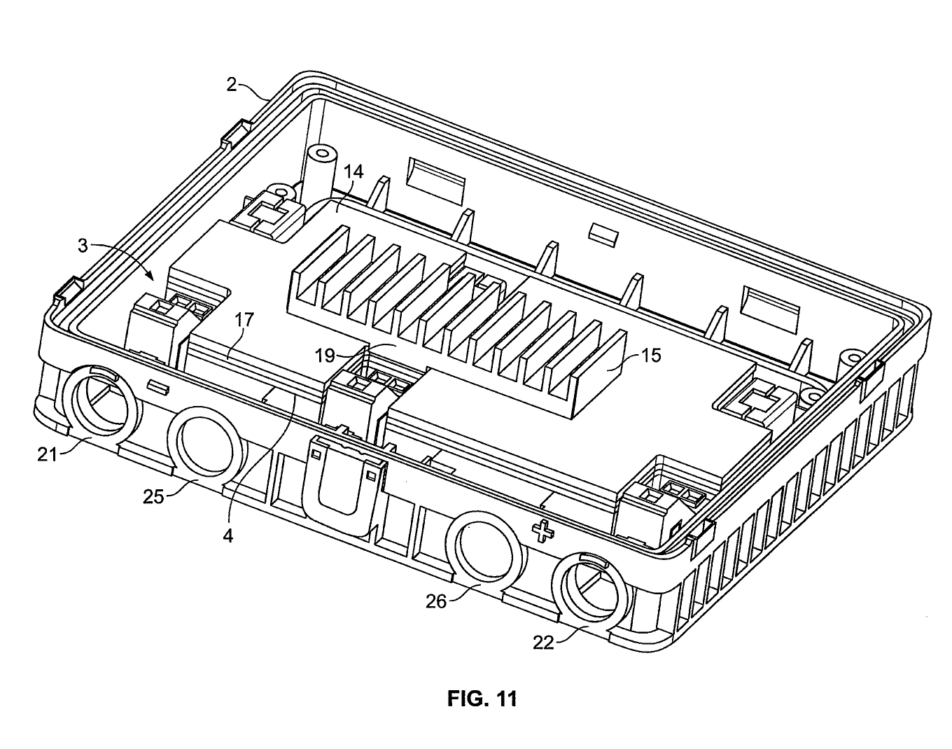

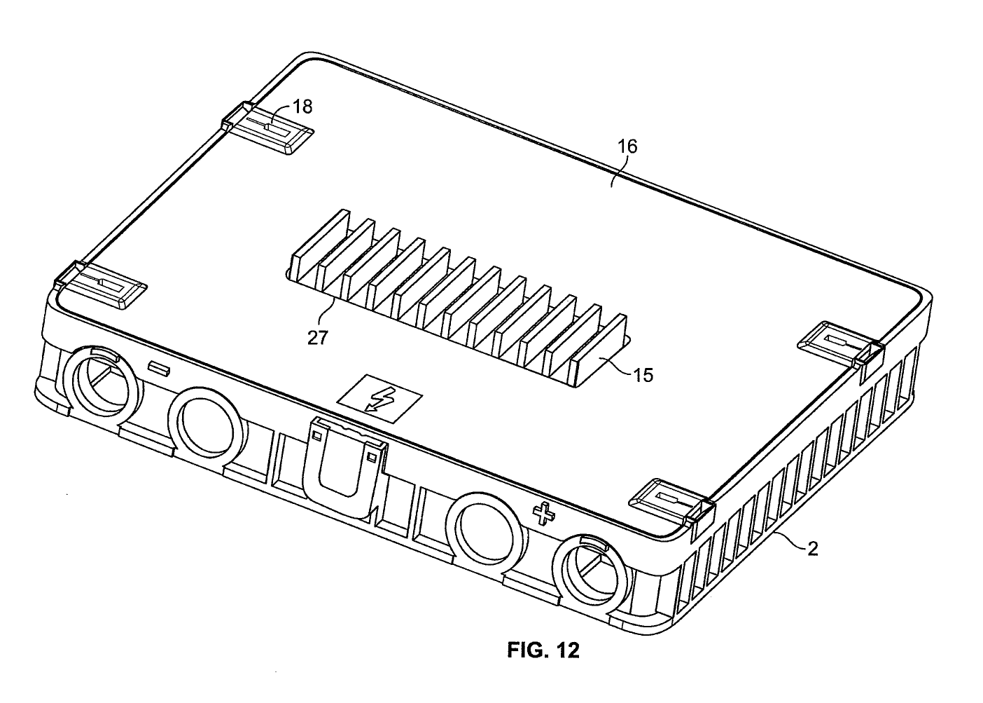

FIGS. 11-12 show a second embodiment of the connection device 1 according to the invention, wherein the thermal conduction structure is connected to one or more external heat sinks 15 to dissipate the thermal energy to the outside of the connector housing 2. In this embodiment, the heat sink 15 is formed as a ribbed body in order to create as large a cooling surface area as possible for dissipating the generated heat.

The thermal conduction structure further includes a plate 14, for example, an anodized aluminum plate, which at least partially covers the intermediate connection arrangement 3. The plate 14 is connected to the external heat sink 15 at a central feedthrough. For example, the plate 14 and the heat sink 15 may be a common component, wherein a sub-area of the plate 14 is arranged inside the connector housing 2 and a sub-area of the heat sink 15 is arranged outside the connector housing 2. The plate 14 absorbs thermal energy from the intermediate connection arrangement 3 via a lower surface and emits the thermal energy via the heat sink 15.

A layer 17 is arranged between the substrate arrangement of the printed circuit board 4 and the plate 14. The layer 17 may be, for example, a non-electrically conductive heat conducting paste. The layer 17 may be used, for example, to fill any rough surfaces of the printed circuit board 4 so that a substantially smooth support surface is formed for the plate 14. Thermal resistance can thereby be minimized, because contact can be made almost the entire surface of the plate 14. Alternatively, the layer 17 may be a heat-conducting pad, which has a harder consistency than the heat-conducting paste and can be used to smooth out less sharp areas of unevenness on the printed circuit board 4.

The plate 14 is configured and arranged in such a way that air gaps and leakage paths to live components (dependent on the voltage level being used in the given case), as specified in the relevant International Electrotechnical Commission (IEC) standard, are observed between the metal parts of the plate 14 or the heat sink 15 and live parts of the intermediate connection arrangement 3. The layer 17 is suitably configured and dimensioned to ensure observation of these air gaps and leakage paths.

As shown in FIG. 12, the connector housing 2 is provided with a connector housing cover 16, which closes off the connector housing 2 in an upper area of the connector housing 2 from the outside thereof. The connector housing cover 16 may be held, for example, on the connector housing 2 by catches 18. A heat sink receiving through-hole 27 is provided in the connector housing cover 16 and in the connector housing 2 as a whole, for the passage of a thermal conductor 19, which is connected to the plate 14 and the external heat sink 15, to dissipate the thermal energy absorbed by the plate 14 to the outside of the connector housing 2 via the cooling ribs of the heat sink 15.

In this embodiment, if the diodes 5 in the intermediate connection arrangement 3 are arranged on the underside of the printed circuit board 4, the thermal energy is dissipated via the rear side 4-2 of the printed circuit board 4. The encapsulation material 7 as described with reference to FIGS. 6-7D is therefore not absolutely essential in this configuration.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A connection device for connecting at least one electrical conductor to at least one connecting lead, comprising:
a connector housing having at least one connecting lead receiving through-hole and at least one electrical conductor receiving through-hole;
an intermediate connection arrangement arranged in the connector housing that has a first connection area configured for connecting the connecting lead and a second connection area configured for connecting the electrical conductor, the intermediate connection arrangement including a substrate arrangement having an electrical conductor structure and a thermal conduction structure, the electrical conductor structure configured for electrically connecting the first connection area to the second connection area and the thermal conduction structure configured to dissipate thermal energy from at least one diode; and
the diode having substantially flat opposing main faces, the diode being electrically connected to the electrical conductor structure and at least one of the main faces being connected to the thermal conduction structure.

2. The connection device of claim 1, wherein the electrical conductor structure is a plurality of tracks.

3. The connection device of claim 2, wherein the diode electrically connects adjacent tracks.

4. The connection device of claim 1, wherein the thermal conduction structure is a plurality of tracks.

5. The connection device of claim 1, wherein the electrical conductor structure comprises at least part of the thermal conduction structure.

6. The connection device of claim 1, wherein the thermal conduction structure is an encapsulation material.

7. The connection device of claim 1, wherein the substrate arrangement is a punched grid.

8. The connection device of claim 1, wherein the substrate arrangement is a printed circuit board.

9. The connection device of claim 1, wherein the thermal conduction structure is a metal plate.

10. The connection device of claim 1, further comprising a heat sink connected to the thermal conduction structure, the heat seat being arranged at least partially outside of the connector housing.

11. The connection device of claim 10, wherein the heat sink has a plurality of ribs arranged outside of the connector housing.

12. The connection device of claim 1, wherein the connection device is a component of a solar module.

13. The connection device of claim 1, wherein the substrate arrangement is a printed circuit board and the thermal conduction structure and the electrical conductor structure comprises a plurality of tracks formed on a front surface and a rear surface of the printed circuit board, the tracks on the front surface and the rear surface of the printed circuit board being connected to each other.

14. The connection device of claim 13, wherein the tracks on the front surface and the rear surface of the printed circuit board are connected by plated through-holes.

15. The connection device of claim 1, wherein the diode is connected to the electrical conductor structure by at least one lead.

16. The connection device of claim 1, wherein the diode further includes side faces that are smaller than the main faces.
